(19) United States
(12) Patent Application Publication
(10) Pub. No.: US 2026/0112160 A1
(43) Pub. Date: Apr. 23, 2026

(54) METHOD AND SYSTEM FOR CONTENT ANALYSIS

(71) Applicant: ONIBER SOFTWARE PRIVATE LIMITED, Pune (IN)

(72) Inventors: Raghu Sesha Iyengar, Bangalore (IN); Ankush Tiwari, Pune (IN); Abhijeet Zilpelwar, Pune (IN); Kapardi Mallampalli, Ranga Reddy District (IN); Harshal Bhore, Pune (IN)

(21) Appl. No.: 19/365,176

(22) Filed: Oct. 22, 2025

(30) Foreign Application Priority Data
Oct. 22, 2024 (IN) 202421080425

(51) Int. Cl. G06V 20/40; G06N 3/0464; G06N 3/048; G06N 3/08; G06V 10/77; G06V 10/82; G06V 40/16

(52) U.S. Cl. CPC G06V 20/41; G06N 3/0464; G06N 3/048; G06N 3/08; G06V 10/7715; G06V 10/82; G06V 40/172

(57) ABSTRACT

The present invention relates to a method (300) and system (100) for detecting the source of media files, specifically aimed at identifying synthetic sources using classification models. The system (100) comprises a processor (201) and memory (202) configured to execute programmed instructions for analyzing input media. Initially, an input media file is received and pre-processed to enhance data quality. The system (100) splits the media into manageable chunks, allowing for the extraction of key features relevant to source identification. These features are then transformed into embeddings using a pre-trained model designed for this purpose. A classification model processes these embeddings to determine the probability of each chunk originating from a synthetic source. By utilizing techniques such as cross-entropy loss and fine-tuning, the system accurately distinguishes between real and synthetic sources. This invention addresses the growing need for reliable source detection in media files, providing a robust solution.

### CROSS-REFERENCE TO RELATED APPLICATIONS AND PRIORITY

The present application claim priority from Indian Patent Application no. 202421080425 filed on 22 Oct. 2024.

### TECHNICAL FIELD

The presently disclosed embodiments are related, in general, to the field of media content analysis. More specifically, the present disclosure focuses on identifying the authenticity of media files by detecting synthetic origins through the application of advanced classification models and feature extraction techniques.

### BACKGROUND

This section is intended to introduce the reader to various aspects of the relevant technical field of media analysis and content classification systems, which are related to aspects of the present disclosure described or claimed below. This discussion is believed to be helpful in providing background information to facilitate a better understanding of the various aspects of the present disclosure. Accordingly, it should be understood that these statements in this background section are to be read in this light, and not as admissions of prior art. Similarly, a problem is mentioned in the background section.

In recent years, synthetic media generation technologies have rapidly evolved, driven by advancements in machine learning and deep neural networks. The ability to produce high-quality synthetic media that closely mimics real human or real world is now within reach of not only specialized industries but also the general public. Many of these sophisticated synthetic media generation tools are readily accessible via cloud-based platforms, either for free or through subscription-based services. As a result, synthetic media content is becoming increasingly ubiquitous across various sectors, ranging from entertainment and virtual assistants to more controversial uses, such as deepfakes and deceptive media.

The challenge of differentiating synthetic media from real media has grown substantially as these synthetic models have improved. State-of-the-art models can replicate not only the tonal quality and accent of a speaker but also subtle speech patterns and idiosyncrasies that make the media nearly indistinguishable from genuine human speech. In many instances, even trained listeners or traditional media analysis systems struggle to reliably detect the synthetic nature of these media samples. This presents a significant challenge, particularly in security, law enforcement, and media integrity applications, where distinguishing real from fake content is critical to maintaining trust and authenticity.

While detecting whether media is synthetic or real is an important first step, a more complex and pressing issue lies in identifying the specific source or model responsible for generating the synthetic media. The proliferation of various synthetic media generation platforms, each utilizing different models, architectures, and techniques, has made it increasingly difficult to trace the origins of synthetic content. Such information could be invaluable in contexts where the media content is potentially harmful, offensive, or involved in criminal activities. For example, in cases where synthetic media is used to deceive or manipulate individuals, knowing the exact model or tool that generated the media could provide law enforcement agencies with crucial insights for forensic investigations.

Existing media analysis systems are largely focused on content detection rather than source identification. These systems are typically designed to determine whether a media file is real or synthetic by analyzing acoustic features such as pitch, tone, and rhythm. However, the ability to identify the source (or synthetic model) behind a generated media file offers a deeper layer of analysis, especially when dealing with malicious or illegal content. Such capabilities could assist investigative authorities in tracing the origins of manipulated media, helping to prevent the spread of disinformation or prosecuting individuals responsible for creating deceptive content. Furthermore, the ability to classify not only the authenticity of media content but also the specific model or source used to generate synthetic media holds significant value in forensic and legal scenarios. For instance, if an offensive or defamatory media clip is circulated online, the ability to identify the synthetic model used to create that content can provide investigators with a concrete lead, narrowing down the list of potential tools or individuals involved. This could streamline investigative efforts, allowing authorities to act quickly and efficiently in cases of digital impersonation, media-based fraud, or other cybercrimes.

The need for advanced media content classification systems that can detect synthetic media and pinpoint the specific generation source has never been greater. In an era where digital content manipulation is becoming more prevalent and accessible, providing law enforcement agencies, security organizations, and investigative bodies with tools to accurately trace the origins of synthetic media can drastically enhance the effectiveness of investigations. Such systems would not only improve the reliability of media analysis but also strengthen accountability in digital media creation, offering a much-needed layer of protection against the misuse of synthetic media in harmful contexts.

Therefore, there is a long felt need for a system that goes beyond traditional speaker identification and media authenticity checks. A system that not only detects synthetic media but also accurately classifies the underlying model or tool responsible for its creation would provide critical support to law enforcement, security agencies, and other entities tasked with preserving media integrity and investigating media-based offences. The proposed invention addresses this need by offering a novel approach to synthetic media detection and source identification, thereby enhancing the reliability of media analysis in a wide range of critical applications.

### SUMMARY

Before the present system and device and its components are summarized, it is to be understood that this disclosure is not limited to the system and its arrangement as described, as there can be multiple possible embodiments which are not expressly illustrated in the present disclosure. The present disclosure overcomes one or more shortcomings of the prior art and provides additional advantages discussed throughout the present disclosure. Additional features and advantages are realized through the techniques of the present disclosure. It is also to be understood that the terminology used in the description is for the purpose of describing the versions or embodiments only and is not intended to limit the scope of the present application.

This summary is provided to introduce concepts related to a method for content analysis, specifically aimed at detecting the source of media files, whether real or synthetic. The system focuses on identifying the origin of synthetic media content within the media file. The detailed description further elaborates on these concepts, and this summary is not intended to identify essential features of the claimed subject matter, nor is it intended for use in determining or limiting the scope of the claimed subject matter.

According to embodiments illustrated in the present disclosure, the method involves receiving an input media file via a processor and performing preprocessing steps to enhance the file's readiness for analysis. The pre-processed media file may then be split into one or more chunks, and one or more media features corresponding to each chunk of the one or more chunks are extracted. A pre-trained media transformer may be used to generate embeddings for each chunk based on the extracted one or more media features.

In one embodiment, the generated embeddings are provided to a set of classification models, including a first and second classification model. Based on the generated embeddings, the first classification model may calculate a synthetic content classification score, indicating probability of each chunk from the one or more chunks to be real or synthetic. Further based on the generated embeddings and the synthetic content classification score, the second classification model may calculate a synthetic source classification score, determining the likelihood of each chunk from the one or more chunks originating from a synthetic source from one or more synthetic sources. Further, the method may provide information regarding the input media file, including whether the media is real or fake and a source of input media file. The source may be one of the one or more synthetic sources in case of the fake media or may be no source from the one or more synthetic sources in case of the real media. This allows users to easily understand the classification results and source determination via the provided information.

The method described herein may utilize multiple classification models trained with real and synthetic datasets, which may include a combination of loss functions such as cross-entropy and triplet loss models. These loss functions are applied to identify incorrect classifications and to further update the models through a backpropagation technique, ensuring improved performance and precision in content analysis.

The method and system described herein may comprise a user interface (UI), a processor, and a memory configured to store executable instructions that, when executed by the processor, perform the steps of the method. These steps include receiving the input media file, preprocessing the received media file, splitting the pre-processed media file into one or more chunks, providing the chunks to a pre-trained media transformer for embedding generation, and applying classification models on the generated embeddings to generate the corresponding classification scores. The processor utilizes these scores to determine whether the media is real or synthetic and to identify the source of any synthetic media content. Additionally, the disclosure may include a non-transitory computer-readable medium to store the instructions, ensuring efficient execution of the media analysis process across various applications.

The scope of this invention is primarily limited to detecting the source of media files, with a focus on identifying synthetic origins using classification models trained with relevant datasets. The classification models are optimized for this specific function, utilizing various loss functions and backpropagation techniques for accurate source detection. Any other aspects, including modelling or prediction beyond this detection of source of the media file, are outside the scope of this application.

The foregoing summary is illustrative and not intended to limit the scope of the claimed subject matter. Further aspects, embodiments, and features will become apparent by reference to the detailed description and accompanying drawings.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements.

The detailed description is described with reference to the accompanying figures. In the figures, same numbers are used throughout the drawings to refer like features and components. Embodiments of a present disclosure will now be described, with reference to the following diagrams below wherein:

FIG. 1 is a block diagram that illustrates a system (100) content analysis in a media file, in accordance with an embodiment of the present subject matter.

FIG. 2 is a block diagram that illustrates various components of an application server (101) configured for performing steps for the content analysis in the media file, in accordance with an embodiment of the present subject matter.

FIG. 3 is a flowchart that illustrates a method (300) for content analysis in the media file, in accordance with an embodiment of the present subject matter.

FIG. 4 illustrates a block diagram (400) of an exemplary computer system for implementing embodiments consistent with the present subject matter.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

The present disclosure may be best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented, and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment. The terms “comprise”, “comprising”, “include(s)”, or any other variations thereof, are intended to cover a non-exclusive inclusion, such that a setup, system or method that comprises a list of components or steps does not include only those components or steps but may include other components or steps not expressly listed or inherent to such setup or system or method. In other words, one or more elements in a system or apparatus preceded by “comprises . . . a” does not, without more constraints, preclude the existence of other elements or additional elements in the system or apparatus.

An objective of the present disclosure is to provide a method and system that enhances the accuracy of content analysis by focusing on detecting the origin of synthetic media files. The system offers high accuracy of content analysis by focusing on detecting the source of synthetic media files.

Another objective of the present disclosure is to design a user-friendly interface for the media analysis system, allowing users to efficiently upload media files, track the processing status, and receive classification results.

Yet another objective of the present disclosure is to enable users to make informed decisions by providing real-time feedback on media file authenticity and classification results. The system allows users to view the synthetic content classification score and synthetic source classification score, helping them assess the likelihood of media manipulation.

Yet another objective of the present disclosure is to optimize the identification and classification process through advanced models, enabling users to obtain accurate results from complex and nuanced media samples while minimizing false positives.

Yet another objective of the present disclosure is to ensure transparency in the system by providing real-time updates on the progress of the media sample analysis, allowing users to track key metrics such as classification score and sample source.

Yet another objective of the present disclosure is to enhance overall user satisfaction by offering flexibility and responsiveness in the interface, enabling users to customize the analysis settings based on their preferences and past results.

Yet another objective of the present disclosure is to employ dynamic threshold adjustments in the classification models, ensuring fair and accurate identification while maintaining high system integrity.

Yet another objective of the present disclosure is to allow users to manage and review their analysis efforts through a dashboard that provides insights into the system's performance, including the accuracy of classification models and comparative analysis of media samples.

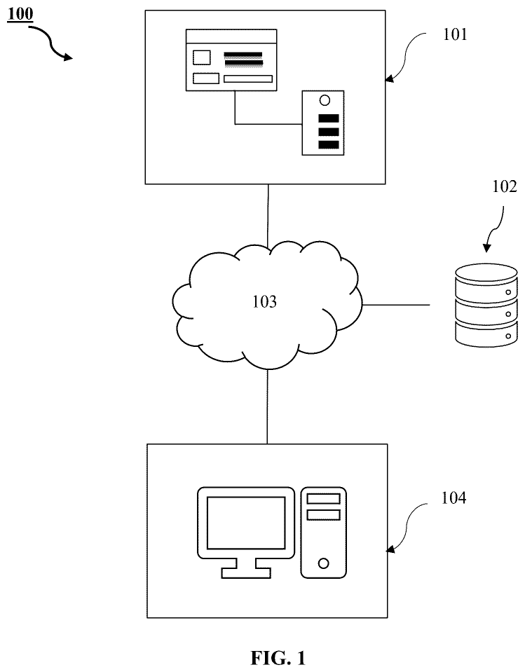

FIG. 1 is a block diagram that illustrates a system (100) for implementing a method for content analysis in an input media file, in accordance with an embodiment of present subject matter. The system (100) typically includes a database server (102), an application server (101), a communication network (103), and one or more portable devices (104). The database server (102), the application server (101), and the one or more portable devices (104) are typically communicatively coupled with each other via the communication network (103). In an embodiment, the application server (101) may communicate with the database server (102), and one or more portable devices (104) using one or more protocols such as, but not limited to, Hypertext Transfer Protocol (HTTP), Transmission Control Protocol/Internet Protocol (TCP/IP), Wireless Application Protocol (WAP), RF mesh, Bluetooth Low Energy (BLE), and the like, to communicate with one another.

In one embodiment, the database server (102) may refer to a computing device configured to store and manage data relevant to the content analysis system. This data may include user profiles, media sample repositories, speaker embeddings, pre-trained media transformer, classification models, and other parameters essential for executing the method of content analysis in media files. The database server (102) ensures that data is securely stored, readily accessible, and accurately updated to support real-time identification and adaptive processing within the system.

In an embodiment, the database server (102) may be a specialized operating system configured to perform one or more database operations on the stored content. Examples of database operations include but are not limited to, selecting, inserting, updating, and deleting media samples, embeddings, and user profiles. This specialized operating system optimizes the efficiency and accuracy of data management, ensuring that the system can quickly respond to real-time requests for content analysis. In an embodiment, the database server (102) may include hardware that may be configured to perform one or more predetermined operations. In an embodiment, the database server (102) may be realized through various technologies such as, but not limited to, Microsoft® SQL Server, Oracle®, IBM DB2®, Microsoft Access®, PostgreSQL®, MySQL®, SQLite®, distributed database technology and the like. In an embodiment, the database server (102) may be configured to utilize the application server (101) for storage and retrieval of data used for media analysis to identify the authenticity and source of the media file, including whether the media file is real or synthetic, and if synthetic, determining the likelihood of its origin from one or more synthetic sources based on the extracted media features and generated embeddings.

A person with ordinary skills in art will understand that the scope of the disclosure is not limited to the database server (102) as a separate entity. In an embodiment, the functionalities of the database server (102) can be integrated into the application server (101) or into the one or more portable device (104).

In an embodiment, the application server (101) may refer to a computing device or a software framework hosting an application, or a software service related to content analysis. In an embodiment, the application server (101) may be implemented to execute procedures such as, but not limited to programs, routines, or scripts stored in one or more memory units to support the operation of the hosted application or software service. In an embodiment, the hosted application or the software service may be configured to perform one or more predetermined operations, including processing media files, generating embeddings of the media file, and facilitating real-time classification of the media content derived from chunks. The application server (101) may also be responsible for managing user interactions, tracking analysis progress, and presenting the classification results in a user-friendly manner on a user interface. The application server (101) may be realized through various types of application servers such as, but are not limited to, a Java application server, a. NET framework application server, a Base4 application server, a PHP framework application server, or any other application server framework.

In an embodiment, the application server (101) may be configured to utilize the database server (102) and the one or more portable device (104), in conjunction, with implementing the method for content analysis in the media file. In an exemplary embodiment, the media processing environment may correspond to a content analysis system. In an implementation, the application server (101) is configured for an automated processing of the input media file including both video and audio components in various formats, such as MP4, AVI, and MKV, to identify the source of the input media file.

In an embodiment, the application server (101) may serve as an infrastructure for executing the method which may include multiple stages of media analysis. Each stage may involve specific steps such as receiving an input media file, preprocessing the media file, and splitting the media file into one or more chunks. Additionally, the system may extract one or more media features corresponding to each chunk and generate embeddings of each chunk using a pre-trained media transformer. Further, the system may provide the generated embeddings to one or more classification models, which may include a first classification model and a second classification model. The application server (101) may then calculate a synthetic content classification score to determine the probability of each chunk being real or fake, and subsequently, calculate a synthetic source classification score to identify whether each chunk belongs to a synthetic source. Finally, the system (100) may provide information indicating whether the media file is real or synthetic and, if synthetic, the source of the synthetic content.

In yet another embodiment, the application server (101) may be configured to receive the input media file.

In yet another embodiment, the application server (101) may be configured to pre-process the received input media file.

In yet another embodiment, the application server (101) may be configured to split the pre-processed input media file into one or more chunks. Each chunk from the one or more chunks may correspond to a segment of the media file, divided based on predefined time intervals or frame counts.

In yet another embodiment, the application server (101) may be configured to extract the one or more features corresponding to each chunk from the one or more chunks. In yet another embodiment, the application server (101) may be configured to generate embeddings of each chunk from the one or more chunks, using the pre-trained media transformer based on the extracted one or more features.

In yet another embodiment, the application server (101) may be configured to classify, via a first classification model, each chunk from the one or more chunks, to determine a synthetic content classification score indicating the likelihood of each chunk being either a real or fake segment. A second classification model may utilize the synthetic content classification score to calculate the synthetic source classification score derived from the embeddings generated for each chunk. This classification process may involve comparing the scores against predefined thresholds to accurately identify the authenticity of the content and its potential source.

In yet another embodiment, the application server (101) may be configured to present to the user via the user interface (UI) each chunk from the one or more chunks with an indication of its source analysis.

In an embodiment, the communication network (103) may correspond to a communication medium through which the application server (101), the database server (102), and the one or more portable device (104) may communicate with each other. Such communication may be performed in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), Wireless Application Protocol (WAP), File Transfer Protocol (FTP), ZigBee, EDGE, infrared IR), IEEE 802.11, 802.16, 2G, 3G, 4G, 5G, 6G, 7G cellular communication protocols, and/or Bluetooth (BT) communication protocols. The communication network (103) may either be a dedicated network or a shared network. Further, the communication network (103) may include a variety of network devices, including routers, bridges, servers, computing devices, storage devices, and the like. The communication network (103) may include, but is not limited to, the Internet, intranet, a cloud network, a Wireless Fidelity (Wi-Fi) network, a Wireless Local Area Network (WLAN), a Local Area Network (LAN), a cable network, the wireless network, a telephone network (e.g., Analog, Digital, POTS, PSTN, ISDN, xDSL), a telephone line (POTS), a Metropolitan Area Network (MAN), an electronic positioning network, an X.25 network, an optical network (e.g., PON), a satellite network (e.g., VSAT), a packet-switched network, a circuit-switched network, a public network, a private network, and/or other wired or wireless communications network configured to carry data.

In an embodiment, the one or more portable devices (104) may refer to a computing device used by a user. The one or more portable devices (104) may comprise of one or more processors and one or more memory. The one or more memories may include computer readable code that may be executable by one or more processors to perform predetermined operations. In an embodiment, the one or more portable devices (104) may present a web user interface for user participation in the environment using the application server (101). Example web user interfaces presented on the one or more portable devices (104) to display the classification results for each chunk from the input media file, along with visual representations of the synthetic content classification scores and synthetic source classification scores. The interfaces may feature interactive elements that allow users to navigate through the chunks, with options to view detailed information about the media features extracted from each chunk. Examples of the one or more portable devices (104) may include, but are not limited to, a personal computer, a laptop, a computer desktop, a personal digital assistant (PDA), a mobile device, a tablet, or any other computing device.

The system (100) can be implemented using hardware, software, or a combination of both, which includes using where suitable, one or more computer programs, mobile applications, or “apps” by deploying either on-premises over the corresponding computing terminals or virtually over cloud infrastructure. The system (100) may include various micro-services or groups of independent computer programs which can act independently in collaboration with other micro-services. The system (100) may also interact with a third-party or external computer system. Internally, the system (100) may be the central processor of all requests for transactions by the various actors or users of the system. A critical attribute of the system (100) is that it may leverage the feeder neural network model, the pre-trained media transformer, and the classification models to process various formats of media, including both audio and video files, for comprehensive content analysis. In a specific embodiment, the system (100) is implemented for content analysis.

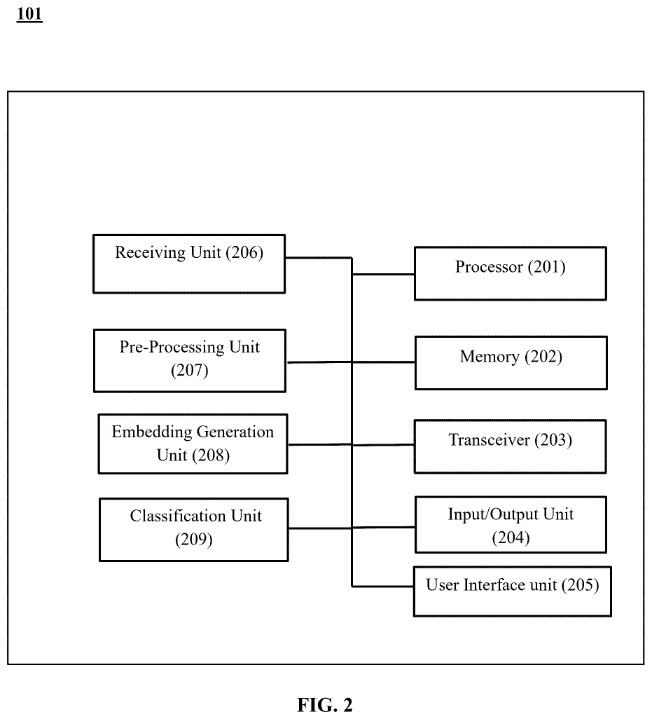

FIG. 2 illustrates a block diagram illustrating various components of the application server (101) configured for performing content analysis on input media files, in accordance with an embodiment of the present subject matter. Further, FIG. 2 is explained in conjunction with elements from FIG. 1. Here, the application server (101) preferably includes a processor (201), a memory (202), a transceiver (203), an Input/Output unit (204), a User Interface unit (205), a Receiving unit (206), a Pre-Processing unit (207), an Embedding Generation unit (208), and a Classification unit (209). The processor (201) is further preferably communicatively coupled to the memory (202), the transceiver (203), the Input/Output unit (204), the User Interface unit (205), the receiving unit (206), the pre-processing unit (207), the embeddings generation unit (208) and the classification unit (209), while the transceiver (203) is preferably communicatively coupled to the communication network (103).

In an embodiment, the application server (101) may be configured to receive the input media file. Further, the application server (101) may be configured to pre-process the received input media file. Further, the application server (101) may be configured to split the pre-processed input media file into one or more chunks using the predefined time interval or the predefined number of frames. Further, each chunk from the one or more chunks may correspond to a distinct segment of the media file, allowing for detailed analysis of the audio and visual data contained within the media file. Furthermore, the application server (101) may extract one or more media features from each chunk, generate embeddings using the pre-trained media transformer based on these features, and provide the generated embeddings to the one or more classification models for subsequent classification and analysis. Furthermore, the application server (101) may calculate the synthetic content classification score and the synthetic source classification score based on the generated embeddings. Moreover, the application server (101) may be configured to provide each chunk from the one or more chunks with an indication of the input media file to be either real or fake and a source of the input media file.

The processor (201) comprises suitable logic, circuitry, interfaces, and/or code that may be configured to execute a set of instructions stored in the memory (202), and may be implemented based on several processor technologies known in the art. The processor (201) works in coordination with the transceiver (203), the Input/Output unit (204), the User Interface unit (205), the receiving unit (206), the pre-processing unit (207), the embeddings generation unit (208) and the classification unit (209) for content analysis in the media file. Examples of the processor (201) include, but not limited to, standard microprocessor, microcontroller, central processing unit (CPU), an X86-based processor, a Reduced Instruction Set Computing (RISC) processor, an Application-Specific Integrated Circuit (ASIC) processor, and a Complex Instruction Set Computing (CISC) processor, distributed or cloud processing unit, state machines, logic circuitries, and/or any devices that manipulate signals based on operational instructions and/or other processing logic that accommodates the requirements of the present invention.

The memory (202) comprises suitable logic, circuitry, interfaces, and/or code that may be configured to store the set of instructions, which are executed by the processor (201). Preferably, the memory (202) is configured to store one or more programs, routines, or scripts that are executed in coordination with the processor (201). Additionally, the memory (202) may include any computer-readable medium or computer program product known in the art including, for example, volatile memory, such as static random-access memory (SRAM) and dynamic random-access memory (DRAM), and/or non-volatile memory, such as read only memory (ROM), erasable programmable ROM, a Hard Disk Drive (HDD), flash memories, Secure Digital (SD) card, Solid State Disks (SSD), optical disks, magnetic tapes, memory cards, virtual memory and distributed cloud storage. The memory (202) may be removable, non-removable, or a combination thereof. Further, the memory (202) may include routines, programs, objects, components, data structures, etc., which perform particular tasks or implement particular abstract data types. The memory (202) may include programs or coded instructions that supplement the applications and functions of the system (100). In one embodiment, the memory (202), amongst other things, may serve as a repository for storing data processed, received, and generated by one or more of the programs or coded instructions. In an exemplary embodiment, the stored data may include pre-processed input media files, extracted media features, generated embeddings, synthetic content classification scores, synthetic source classification scores, and associated metadata. In yet another embodiment, the memory (202) may be managed under a federated structure that enables the adaptability and responsiveness of the application server (101).

The transceiver (203) comprises suitable logic, circuitry, interfaces, and/or code that may be configured to receive, process or transmit information, data or signals, which are stored by the memory (202) and executed by the processor (201). The transceiver (203) is preferably configured to receive, process or transmit, one or more programs, routines, or scripts that are executed in coordination with the processor (201). The transceiver (203) is preferably communicatively coupled to the communication network (103) of the system (100) for communicating all the information, data, signal, programs, routines or scripts through the network.

The transceiver (203) may implement one or more known technologies to support wired or wireless communication with the communication network (103). In an embodiment, the transceiver (203) may include but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. Also, the transceiver (203) may communicate via wireless communication with networks, such as the Internet, an Intranet and/or a wireless network, such as a cellular telephone network, a wireless local area network (LAN) and/or a metropolitan area network (MAN). Accordingly, the wireless communication may use any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The input/output (I/O) unit (204) comprises suitable logic, circuitry, interfaces, and/or code that may be configured to receive or present information. The input/output unit (204) comprises various input and output devices that are configured to communicate with the processor (201). Examples of the input devices include, but are not limited to, a keyboard, a mouse, a joystick, a touch screen, a microphone, a camera, and/or a docking station. Examples of the output devices include, but are not limited to, a display screen and/or a speaker. The I/O unit (204) may include a variety of software and hardware interfaces, for example, a web interface, a graphical user interface, and the like. The I/O unit (204) may allow the system (100) to interact with the user directly or through the portable devices (104). Further, the I/O unit (204) may enable the system (100) to communicate with other computing devices, such as web servers and external data servers (not shown). The I/O unit (204) can facilitate multiple communications within a wide variety of networks and protocol types, including wired networks, for example, LAN, cable, etc., and wireless networks, such as WLAN, cellular, or satellite. The I/O unit (204) may include one or more ports for connecting a number of devices to one another or to another server. In one embodiment, the I/O unit (204) allows the application server (101) to be logically coupled to other portable devices (104), some of which may be built in. Illustrative components include tablets, mobile phones, desktop computers, wireless devices, etc.

In an embodiment, the input/output unit (204) may be configured to facilitate communication between the application server (101) and external devices, enabling seamless data transfer and user interaction. The input/output unit (204) may support various input devices, such as keyboards, touchpads, and trackpads, allowing users to provide input commands and navigate the user interface efficiently. Additionally, the input/output unit (204) may be configured to output processed data and analysis results through display devices, ensuring that users can easily interpret and utilize the information generated by the application server (101). Furthermore, the input/output unit (204) may incorporate connectivity options, such as USB, Bluetooth, or Wi-Fi, to enhance its capability to integrate with other systems and portable devices, thereby improving the overall user experience and functionality of the content analysis system.

Further, the user interface unit (205) may include the user interface (UI) designed to facilitate interaction with the system (100) for content analysis. In an exemplary embodiment, the UI may allow users to upload the input media file for analysis. In an exemplary embodiment, users can interact with the UI through voice or text commands to initiate various operations, such as executing media analysis tasks or adjusting parameters based on their preferences. In an exemplary embodiment, the UI may display the current status of the content analysis process, and a classified portion of the media file to the user. Additionally, the user interface (UI) of the system is designed to support multiple media formats, enabling user interaction with the input media file in the form of a video or audio. In an exemplary embodiment, the UI allows users to manage and modify the analysis task of the video content in real time, ensuring that their specific needs are met. The UI may also display relevant information regarding the analysis process, including the pre-processing status, object extraction, and analysis of the one or more chunks. Furthermore, the UI may present the classification of each chunk as either real or synthetic with corresponding source through visual indicators, alerts, and detailed notifications, keeping users informed of the analysis outcomes. This approach may enhance user engagement with the system, as it addresses the limitations of conventional systems by accurately identifying synthetic portions within the received input media file. Additionally, the UI may provide users with comprehensive insights into the synthetic content classification score and synthetic source classification score for each chunk, facilitating informed decision-making based on the analysis results.

In another embodiment, the receiving unit (206) of the application server (101), is disclosed. The receiving unit (206) is configured for receiving the input media file. In an exemplary embodiment, the receiving unit (206) may allow the system to receive input media files, including audio and video content, in various formats. For audio, the formats may include MP3, WAV, AAC, FLAC, OGG, WMA, and AIFF. For video, the formats may encompass MP4, AVI, MKV, MOV, WMV, FLV, and WEBM, or a combination thereof. The receiving unit (206) may verify the file format and size to ensure compatibility with the system's processing capabilities. Upon successful validation, the receiving unit (206) may transmit the media file to the processor (201) for further analysis.

Further, the pre-processing unit (207) may be configured to pre-process the received input media file. In an embodiment, the pre-processing unit (207) may be configured to pre-process the received input media file for sampling the received input media file based on a predefined sampling rate. In another embodiment, the pre-processing unit (207) may be configured to pre-process the received input media file based on a predefined frame sampling rate. In another embodiment, the pre-processing unit (207) may be configured to filter the sampled input media file in the time domain to reduce either noise or artifacts in the frequency domain, thereby preparing the media file for further analysis. In an exemplary embodiment, filtering of the sampled input media file may be performed using one of hamming window, hanning window, low pass filter, high pass filter, band pass filter or a combination thereof.

In yet another embodiment, the pre-processing unit (207) may be configured to pre-process the received input media file to identify the one or more portions associated with one or more users, within the received input media file. The one or more portions may correspond to either voice information or facial information associated with the one or more users. The facial information associated with the one or more users may be identified using one of Multi-task Cascaded Convolutional Networks (MTCNN), Yoloface, deepFace, retinaFace, FaceNet, or a combination thereof.

Furthermore, the pre-processing unit (207) may be configured to split the pre-processed input media file into the one or more chunks. In one embodiment, splitting the pre-processed input media file into one or more chunks may be performed using a pre-defined time interval. In another embodiment, splitting of the video data of the received input media file into one or more chunks is performed either using the predefined time interval or a predefined number of frames. In a specific embodiment, the splitting of the video data of the received input media file may be performed by grouping the predefined number of frames for each face from the facial information associated with one or more faces of the one or more users. In an embodiment, each chunk from the one or more chunks corresponds to the plurality of frames associated with one or more portions with the one or more users. In an embodiment, the plurality of frames may be associated with either a facial image or a non-facial image. In an embodiment, each chunk from the one or more chunks, obtained by the splitting, may be partially overlapping with an adjacent chunk of the one or more chunks.

In an exemplary embodiment, the splitting of the media into overlapping chunks may significantly enhance the accuracy of detecting synthetic alterations, particularly when small changes occur at different parts of the video. By introducing a 50% overlap, the chunks might become 0-2 seconds, 1-3 seconds, 2-4 seconds, and so on. This overlapping allows each chunk to share some frames with its adjacent chunks, ensuring that critical features such as motion continuity, facial expressions, or lighting changes across boundaries are captured and not missed in the analysis.

In an exemplary embodiment, the receiving unit (206) may be configured to allow the user to select a specific chunk from the one or more chunks of the media, to determine the source of the one or more chunks.

Furthermore, the pre-processing unit (207) may be configured to extract one or more media features corresponding to each chunk from the one or more chunks obtained from the input media file. For example, each chunk may be individually examined for features such as pitch, background noise, and vocal content. This feature extraction facilitates more accurate classification during subsequent processing steps, enhancing the overall performance of the analysis. In an exemplary embodiment, the one or more media features may include one of pitch, background noise levels, spectral characteristics, temporal patterns, audio frequency ranges, file format, compression artifacts, channel separation, noise patterns, mel spectrogram, vocal tract model parameters, acoustic parameters, raw sample, frequency changes, a facial key points, swapped faces, cropped faces in RGB color space, YUV color space, masked faces, focussed eye region, lip region, facial expressions duration, number of pixels, number of person, video only, audio-video, frame rate, lighting inconsistencies, reflections, shadows, motion blur, or a combination thereof. These features contribute to the effective analysis of the media content, facilitating accurate classification in subsequent processing steps.

In an embodiment, the pre-processing unit (207) may be configured to stack the extracted one or more media features, before passing to a feeder neural network model, to create a volume of input to the feeder neural network model. In an embodiment, a separate stack is created for the plurality of frames associated with either audio content or video content, enabling the model to analyze and classify the distinct characteristics of each media type effectively. The feeder neural network model may correspond to one of the following models, but not limited to at least one of the convolutional neural network (CNN) layers, VGG (Visual Geometry Group), 3D-CNNs, fully connected layers, sigmoid activation, ReLU (Rectified Linear Unit) activation, dropout layers, ResNet (Residual Networks), RawNet2, LSTM (Long Short-Term Memory), Deep Neural Network (DNN), or a combination thereof.

Further, the embedding generation unit (208) may be configured for generating embeddings of each chunk from the one or more chunks, using a pre-trained media transformer based on the extracted one or more media features. In an embodiment, the embeddings generated by the embedding generation unit (208) may represent multi-dimensional vector representations of each chunk from the one or more chunks, encapsulating the unique characteristics and temporal information of the media content. Furthermore, the pre-embedding generation unit (208) may be configured to input the extracted one or more media features to the feeder neural network model based on the created volume of input, before passing to the pre-trained media transformer, for obtaining a changed activation volume of an input to the pre-trained media transformer. Further, the pre-trained media transformer may correspond to one of the following models, but not limited to, Audio Spectrogram Transformer model, Whisper model, Wav2Vec2, EnCodec, Hubert (Hidden-Unit BERT), VideoMAE, XClip, TimeSformer, ViViT, Vision Transformers (ViTs), BEiT (BERT Pre-Training of Image Transformers), CAiT (Class-Attention in Image Transformers), DeiT (Data-efficient Image Transformers), or a custom transformer-based neural network model designed for multi-modal media processing.

In an exemplary embodiment, embeddings may correspond to vector representations of the one or more media features. These embeddings may be multi-dimensional vector representations of each chunk, for example, represented as vectors with dimensions that may range from 512 to 2048. Specifically, for video processing, each input video chunk may be transformed into a vector of floating-point numbers, such as in case of VideoMAE transformer model, the encoder processes the input video chunks consisting of 16 frames to obtain a 768-dimensional vector representation.

In one embodiment, the pre-trained media transformer utilized by the system (100) is trained using a comprehensive dataset of audio and video samples specifically for the purpose of analyzing content authenticity. The embeddings generated by the pre-trained media transformer may be a multi-dimensional vector representation of each chunk from the one or more chunks. In an exemplary embodiment, in case of the pre-trained media transformer, the feeder neural network may generate an activation volume that aligns with the specific input dimensions expected by the pre-trained media transformer. For example, an output activation volume of a convolutional layer in a neural network could be 224×224×10, representing 10 channels with each channel having a height and a width of 224×224. The feeder neural network model is designed so that its output activation volume aligns with an input dimension required by the pre-trained media transformer namely VideoMAE, which may expect input in a specific format, such as 16×224×224×3. Here, 224×224×3 corresponds to an image with height and width of 224×224 and 3 channels (RGB), and the input consists of 16 such images stacked together. Thus, the embedding generation unit (208) ensures that the output activation volume of the feeder neural network model matches the input dimensions expected by the pre-trained media transformer, enabling seamless data flow and ensuring effective training of both models.

Furthermore, the embedding generation unit (208) may be configured to provide the generated embeddings to one or more classification models. The one or more classification models may comprise a first classification model and a second classification model.

Furthermore, the classification unit (209) may be configured to calculate a synthetic content classification score for each chunk from the one or more chunks, based on the generated embeddings. In an embodiment, the synthetic content classification score may indicate a probability of each chunk being classified as either a real chunk or a fake chunk, thereby facilitating the differentiation of authentic media from synthetic media. Furthermore, the second classification model may utilize the synthetic content classification score and the generated embeddings, to compute a synthetic source classification score, which reflects the likelihood of each chunk belonging to a synthetic source from one or more synthetic sources. This layered classification approach enhances the system's ability to accurately assess and differentiate between authentic and synthetic media content and their corresponding sources.

In an embodiment, the second classification model may be configured to compare the synthetic source classification score of each chunk with a predefined threshold, enabling the classification of the chunk as belonging to the synthetic source from the one or more synthetic sources. In one embodiment, the first and second classification models may comprise a combination of fully connected linear layer neural networks and non-linear layer neural networks, enhancing their capacity for complex pattern recognition. Additionally, the second classification model may employ one or more techniques such as ReLU activation functions, Sigmoid activation functions, logistic regression, random forest algorithms, k-nearest neighbour (k-NN) methods, support vector machines (SVM), or a combination thereof, allowing for flexible and robust classification capabilities across varied data sets.

In one embodiment, the classification unit (209) may be configured for training the second classification model using the one or more chunks of the input media file. During the training process, one or more loss functions may be utilized on the one or more chunks to identify misclassifications, allowing for further updates to the second classification model through a backpropagation technique. The one or more loss functions may include, but are not limited to, a cross-entropy loss model, a triplet loss model, an L2 regularizer, or a combination thereof, thereby enhancing the model's ability to minimize classification errors and improve overall accuracy in classifying the source of the input media chunks.

Further, the application server (101) may be configured to provide an information corresponding to the input media file. The information may comprise an indication of the input media file to be either real or fake and a source of the input media file. The source may be one of the one or more synthetic sources in case of the fake media or may be no source from the one or more synthetic sources in case of the real media.

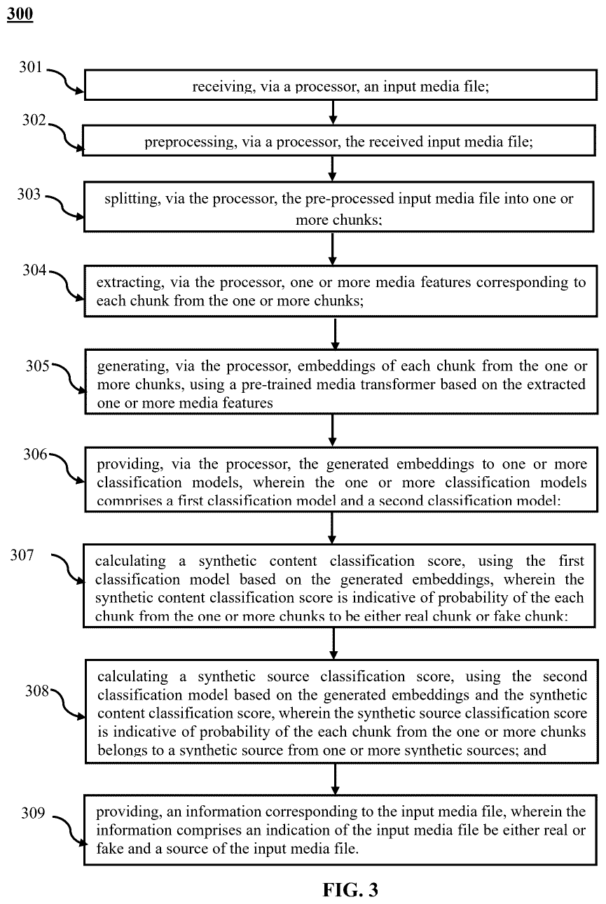

Referring to FIG. 3, a flowchart that illustrates a method (300) for content analysis, in accordance with at least one embodiment of the present subject matter. The method (300) may be implemented by one or more portable devices (104) including the one or more processors (201) and the memory (201) communicatively coupled to the processor (201). The memory (202) is configured to store processor-executable programmed instructions, causing the processor (201) to perform the following steps:

At step (301), the processor (201) is configured to receive the input media file.

At step (302), the processor (201) is configured to pre-process the received input media file into one or more chunks.

At step (303), the processor (201) is configured to split the pre-processed input media file into one or more chunks.

At step (304), the processor (201) is configured to extract one or more features corresponding to each chunk from the one or more chunks.

At step (305), the processor (201) is configured to generate embeddings of each chunk from the one or more chunks, using a pre-trained media transformer based on the extracted one or more media features.

At step (306), the processor (201) is configured to provide the generated embeddings to one or more classification models. In an embodiment, the one or more classification models comprise a first classification model and a second classification model provide.

At step (307), the processor (201) is configured to calculate a synthetic content classification score. In an embodiment using the first classification model based on the generated embeddings, wherein the synthetic content classification score is indicative of probability of the each chunk from the one or more chunks to be either real chunk or fake chunk.

At step (308), the processor (201) is configured to calculate a synthetic source classification score, using the second classification model based on the generated embeddings and the synthetic content classification score. In an embodiment, the synthetic source classification score is indicative of the probability of the each chunk from the one or more chunks belongs to a synthetic source from one or more synthetic sources.

At step (309), the processor (201) is configured to provide an information corresponding to the input media file. In an embodiment, the information comprises an indication of the input media file be either real or fake and a source of the input media file.

These sequence of steps may be repeated and continue till the system stops receiving the input media file.

Let us delve into a detailed example of the present disclosure.

Working Example 1: In this example, the method for content analysis is applied to a dataset comprising audio and video files from various sources, including social media platforms and news outlets.

Input Media File: The processor receives an input media file, such as a 30-second audio clip combined with visual content from a news report discussing a recent event.

Preprocessing: The received media file is pre-processed to remove background noise and enhance audio clarity. The processor splits the media file into multiple overlapping chunks of 5 seconds each.

Feature Extraction: For each 5-second chunk, the processor extracts features such as mel spectrograms for audio and key facial points for the video segments. This step helps to represent the audio characteristics and visual elements effectively.

Embedding Generation: The processor utilizes a pre-trained media transformer to generate embeddings for each chunk based on the extracted features. These embeddings capture the essential attributes of the media content.

Classification Models: The generated embeddings are then provided to two classification models. The first model evaluates the synthetic content classification, while the second model assesses the source classification.

Score Calculation: The synthetic content classification score indicates whether each chunk is likely to be real or fake. For instance, a chunk may receive a score of 0.85, suggesting a high probability of being real content. Concurrently, the synthetic source classification score evaluates the likelihood of the chunk originating from a synthetic source, providing insights into the content's authenticity.

Information Output: The processor compiles the results and provides an output report, indicating that the input media file is real and identifying the source as a reputable news organization.

Continued Analysis: The system continues to analyze additional media files, repeating the above steps to ensure comprehensive content verification.

A person skilled in the art will understand that the scope of the disclosure is not limited to scenarios based on the aforementioned factors and using the aforementioned techniques, and that the examples provided do not limit the scope of the disclosure.

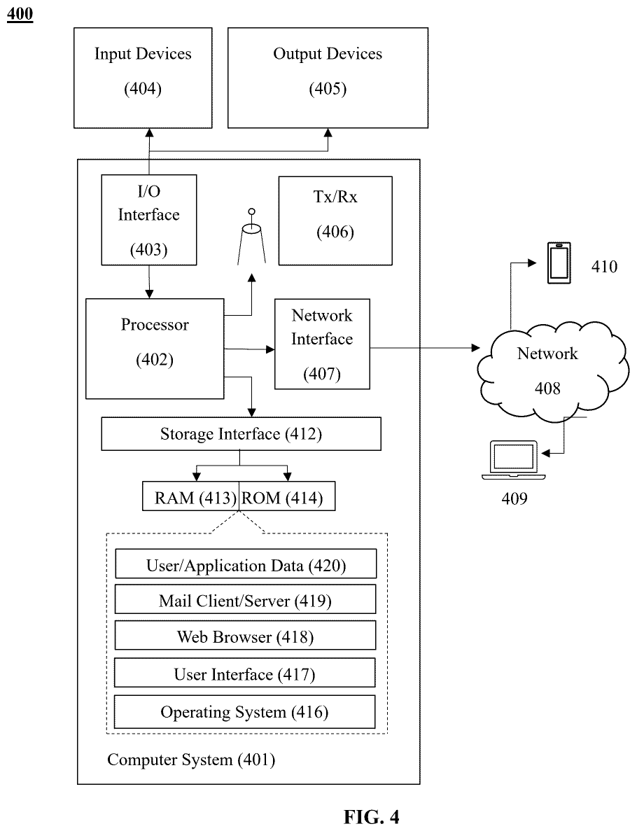

FIG. 4 illustrates a block diagram of an exemplary computer system (401) for implementing embodiments consistent with the present disclosure.

Variations of a computer system (401) may be used for withdrawal of a user from the environment. The computer system (401) may comprise a central processing unit (“CPU” or “processor”) (402). The processor (402) may comprise at least one data processor for executing program components for executing user or system generated requests. A user may include a person, a person using a device such as those included in this disclosure, or such a device itself. Additionally, the processor (402) may include specialized processing units such as integrated system (bus) controllers, memory management control units, floating point units, graphics processing units, digital signal processing units, or the like. In various implementations, the processor (402) may include a microprocessor, such as AMD Athlon, Duron or Opteron, ARM's application, embedded or secure processors, IBM PowerPC, Intel's Core, Itanium, Xeon, Celeron or other line of processors, for example. Accordingly, the processor (402) may be implemented using a mainframe, distributed processor, multi-core, parallel, grid, or other architectures. Some embodiments may utilize embedded technologies like application-specific integrated circuits (ASICs), digital signal processors (DSPs), or Field Programmable Gate Arrays (FPGAs), for example.

Processor (402) may be disposed of in communication with one or more input/output (I/O) devices via an I/O interface (403). Accordingly, the I/O interface (403) may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n//g/n/x, Bluetooth, cellular (e.g., code-division multiple access (CDMA), high-speed packet access (HSPA+), global system for mobile communications (GSM), long-term evolution (LTE), WiMAX, or the like, for example.

Using the I/O interface (403), the computer system (401) may communicate with one or more I/O devices. For example, the input device (404) may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, or visors, for example. Likewise, an output device (405) may be a user's smartphone, tablet, cell phone, laptop, printer, computer desktop, fax machine, video display (e.g., cathode ray tube (CRT), liquid crystal display (LCD), light-emitting diode (LED), plasma, or the like), or audio speaker, for example. In some embodiments, a transceiver (406) may be disposed in connection with the processor (402). The transceiver (406) may facilitate various types of wireless transmission or reception. For example, the transceiver (406) may include an antenna operatively connected to a transceiver chip (example devices include the Texas Instruments® WiLink WL1283, Broadcom® BCM4750IUB8, Infineon Technologies® X-Gold 618-PMB9800, or the like), providing IEEE 802.11a/b/g/n, Bluetooth, FM, global positioning system (GPS), and/or 2G/3G/5G/6G HSDPA/HSUPA communications, for example.

In some embodiments, the processor (402) may be disposed in communication with a communication network (408) via a network interface (407). The network interface (407) is adapted to communicate with the communication network (408). The network interface (407) may employ connection protocols including, without limitation, direct connect, Ethernet (e.g., twisted pair 10/100/1000 Base T), transmission control protocol/internet protocol (TCP/IP), token ring, or IEEE 802.11a/b/g/n/x, for example. The communication network (408) may include, without limitation, a direct interconnection, local area network (LAN), wide area network (WAN), wireless network (e.g., using Wireless Application Protocol), or the Internet, for example. Using the network interface (407) and the communication network (408), the computer system (401) may communicate with devices such as shown as a laptop (409) or a mobile/cellular phone (410). Other exemplary devices may include, without limitation, personal computer(s), server(s), fax machines, printers, scanners, various mobile devices such as cellular telephones, smartphones (e.g., Apple iPhone, Blackberry, Android-based phones, etc.), tablet computers, desktop computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system (401) may itself embody one or more of these devices.

In some embodiments, the processor (402) may be disposed in communication with one or more memory devices (e.g., RAM 413, ROM 414, etc.) via a storage interface (412). The storage interface (412) may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, or solid-state drives, for example.

The memory devices may store a collection of program or database components, including, without limitation, an operating system (416), user interface application (417), web browser (418), mail client/server (419), user/application data (420) (e.g., any data variables or data records discussed in this disclosure) for example. The operating system (416) may facilitate resource management and operation of the computer system (401). Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like.

The user interface (417) is for facilitating the display, execution, interaction, manipulation, or operation of program components through textual or graphical facilities. For example, user interfaces (417) may provide computer interaction interface elements on a display system operatively connected to the computer system (401), such as cursors, icons, check boxes, menus, scrollers, windows, or widgets, for example. Graphical user interfaces (GUIs) may be employed, including, without limitation, Apple Macintosh operating systems'Aqua, IBM OS/2, Microsoft Windows (e.g., Aero, Metro, etc.), Unix X-Windows, or web interface libraries (e.g., ActiveX, Java, JavaScript, AJAX, HTML, Adobe Flash, etc.), for example.

In some embodiments, the computer system (401) may implement a web browser (418) stored program component. The web browser (418) may be a hypertext viewing application, such as Microsoft Internet Explorer, Google Chrome, Mozilla Firefox, Apple Safari, or Microsoft Edge, for example. Secure web browsing may be provided using HTTPS (secure hypertext transport protocol), secure sockets layer (SSL), Transport Layer Security (TLS), or the like. Web browsers may utilize facilities such as AJAX, DHTML, Adobe Flash, JavaScript, Java, or application programming interfaces (APIs), for example. In some embodiments the computer system (401) may implement a mail client/server (419) stored program component. The mail server (419) may be an Internet mail server such as Microsoft Exchange, or the like. The mail server may utilize facilities such as ASP, ActiveX, ANSI C++/C #, Microsoft. NET, CGI scripts, Java, JavaScript, PERL, PHP, Python, or WebObjects, for example. The mail server (419) may utilize communication protocols such as internet message access protocol (IMAP), messaging application programming interface (MAPI), Microsoft Exchange, post office protocol (POP), simple mail transfer protocol (SMTP), or the like. In some embodiments, the computer system (401) may implement a mail client (420) stored program component. The mail client (420) may be a mail viewing application, such as Apple Mail, Microsoft Entourage, Microsoft Outlook, or Mozilla Thunderbird.

In some embodiments, the computer system (401) may store user/application data (421), such as the data, variables, records, or the like as described in this disclosure. Such databases may be implemented as fault-tolerant, relational, scalable, secure databases such as Oracle or Sybase, for example. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of any computer or database component may be combined, consolidated, or distributed in any working combination.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer readable medium” should be understood to include tangible items and exclude carrier waves and transient signals, i.e., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

Various embodiments of the disclosure encompass numerous advantages including methods and systems for content analysis. The disclosed method and system have several technical advantages, but not limited to the following:

Accurate Detection of Synthetic Content: The system is capable of precisely identifying synthetic media content, including deepfakes or AI-generated voices, by leveraging advanced feature extraction techniques and pre-trained transformer models. This enables real-time identification of manipulated or synthetic content, ensuring authenticity and reliability.

Enhanced Feature Extraction: The system extracts a wide range of media features, such as facial movements in videos or spectral patterns in media files, allowing for in-depth analysis and detection of subtle manipulations that traditional systems may overlook.

Transformer-Based Embedding Generation: By utilizing transformer models for media content analysis, the system generates high-quality embeddings that represent complex patterns in the data, leading to more robust and scalable content classification. Scalability and Flexibility: The system is designed to handle large volumes of media content in real-time, making it suitable for diverse use cases, including live media broadcasting, legal investigations, and digital content verification. Additionally, the system can be adapted to analyze different types of media files, such as video, audio, or combined formats.

Source Identification Capabilities: Beyond classifying content as real or synthetic, the system can also identify the potential source of synthetic media. This enables organizations to trace the origins of manipulated content and take appropriate actions to prevent further distribution.

Seamless Integration with Existing Platforms: The system can be integrated into existing content distribution or verification platforms, enhancing their ability to automatically detect and flag suspicious media without disrupting existing workflows. Reduction of False Positives: The system's dual-classification approach, which involves both content and source classification, reduces the risk of false positives by cross-verifying the results of multiple models, ensuring a higher degree of accuracy in content analysis.

Real-Time Feedback: The system provides real-time feedback and reports on the authenticity of media content, which is especially critical in environments where timely decisions are needed, such as live news broadcasts or legal proceedings.

In summary, these technical advantages solve the technical problem of providing a reliable and efficient system for content analysis, including the limitations in accurately identifying complex synthetic manipulations, processing large media files efficiently, and reliably extracting intricate features such as subtle facial movements or lighting discrepancies. Furthermore, traditional systems often struggle with handling diverse media formats, leading to compatibility issues and inconsistent results. They may also rely on outdated classification models, resulting in higher false positive or negative rates when identifying manipulated content. Additionally, many legacy systems face scalability and adaptability challenges, particularly in dynamic environments such as social media platforms or broadcast networks. By addressing these limitations, the present system provides a more efficient, accurate, and adaptable solution for content analysis, ensuring reliable detection and classification of media across various contexts.

The claimed invention of the system and the method for content analysis addresses the need for a reliable and efficient mechanism to detect and classify media content, particularly focusing on identifying synthetic origins. In an era where deepfake technology and media manipulation are prevalent, there is an urgent demand for tools that can accurately analyze media files and discern between authentic and manipulated content. This invention fulfils the need for advanced analytical capabilities that utilize machine learning and feature extraction techniques, allowing for the comprehensive examination of diverse media types. Moreover, it caters to the requirements of various industries, including journalism, entertainment, and cybersecurity, by providing a scalable solution that enhances content verification processes, reduces misinformation, and safeguards the integrity of media. Through its innovative approach, the system not only improves accuracy but also ensures a faster response time in assessing media authenticity, thereby reinforcing trust in digital content.

Furthermore, the invention involves a non-trivial combination of technologies and methodologies that provide a technical solution for a technical problem—specifically, the challenge of accurately detecting synthetic media while minimizing false positives and false negatives. Traditional methods often struggle with the complexity and subtlety of manipulated content, leading to unreliable classifications that can compromise the integrity of media analysis. This invention leverages advanced machine learning algorithms, feature extraction techniques, and robust classification models to create a comprehensive framework capable of analyzing media content at a granular level. By integrating these technologies, the system effectively addresses the intricacies of synthetic media detection, ensuring a higher degree of precision in identifying authentic versus manipulated content. This not only enhances the reliability of content verification processes but also empowers users with actionable insights to combat misinformation in various applications.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like. The claims can encompass embodiments for hardware and software, or a combination thereof.

While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure is not limited to the particular embodiment disclosed, but that the present disclosure will include all embodiments falling within the scope of the appended claims.

1. A method (300) for content analysis, the method (300) comprising:
receiving (301), via a processor (201), an input media file;
preprocessing (302), via a processor (201), the received input media file;
splitting (303), via the processor (201), the pre-processed input media file into one or more chunks;
extracting (304), via the processor (201), one or more media features corresponding to each chunk from the one or more chunks;
generating (305), via the processor (201), embeddings of each chunk from the one or more chunks, using a pre-trained media transformer based on the extracted one or more media features;
providing (306), via the processor (201), the generated embeddings to one or more classification models, wherein the one or more classification models comprises a first classification model and a second classification model;
calculating (307), a synthetic content classification score, using the first classification model based on the generated embeddings, wherein the synthetic content classification score is indicative of probability of the each chunk from the one or more chunks to be either real chunk or fake chunk;
calculating (308), a synthetic source classification score, using the second classification model based on the generated embeddings and the synthetic content classification score, wherein the synthetic source classification score is indicative of probability of the each chunk from the one or more chunks belongs to a synthetic source from one or more synthetic sources; and
providing (309), an information corresponding to the input media file, wherein the information comprises an indication of the input media file to be either real or fake and a source of the input media file.

2. The method (300) as claimed in claim 1, wherein the input media file comprises a combination of an audio data and a video data, wherein preprocessing the received input media file corresponds to sampling the audio data of the received input media file based on a predefined sampling rate, wherein preprocessing the received input media file corresponds to sampling the video data of the received input media file based on a predefined frame sampling rate; wherein the method (300) comprises filtering the sampled input media file in time domain to reduce either noise or artifacts in the frequency domain, wherein filtering of the sampled input media file is performed using one of hamming window, hanning window, low pass filter, high pass filter, band pass filter or a combination thereof; wherein the method (300) comprises preprocessing the input media file for identifying one or more portions associated with one or more users, within the received input media file, wherein the one or more portions corresponds to, either voice information or facial information, associated with the one or more users, wherein the facial information associated with the one or more users are identified by using one of Multi-task Cascaded Convolutional Networks (MTCNN), Yoloface, deepFace, retinaFace, FaceNet or a combination thereof.

3. The method (300) as claimed in claim 2, wherein splitting the pre-processed input media file into one or more chunks is performed using a pre-defined time interval, wherein splitting of the video data of the received input media file into one or more chunks is performed either using the predefined time interval or a predefined number of frames; wherein the splitting of the video data of the received input media file is performed by grouping the predefined number of frames for each face from the facial information associated with one or more faces of the one or more users; wherein each chunk from the one or more chunks, obtained by the splitting, is partially overlapping with an adjacent chunk of the one or more chunks.

4. The method (300) as claimed in claim 1, wherein the one or more media features comprises one of a mel spectrogram, vocal tract model parameters, acoustic parameters, background noise, raw sample, pitch, frequency changes, a facial key points, swapped faces, cropped faces in RGB color space, YUV color space, masked faces, focussed eye region, lip region, facial expressions duration, number of pixels, number of person, video only, audio-video, file format, frame rate, compression artifacts, lighting inconsistencies, reflections, shadows, motion blur, noise patterns, or a combination thereof.

5. The method (300) as claimed in claim 1, comprises stacking the extracted one or more media features, before passing to a feeder neural network model, to create a volume of input to the feeder neural network model; wherein the method (300) comprises providing the extracted one or more features to the feeder neural network model based on the created volume of input, before passing to the pre-trained media transformer for obtaining a changed activation volume of an input to the pre-trained media transformer.

6. The method (300) as claimed in claim 1, wherein the feeder neural network model corresponds to at least one of a convolutional neural network (CNN) layers, VGG (Visual Geometry Group), 3D-CNNs, fully connected layers, sigmoid activation, ReLU (Rectified Linear Unit) activation, dropout layers, ResNet (Residual Networks), RawNet2, LSTM (Long short-term memory), Deep Neural Network (DNN), or a combination thereof.

7. The method (300) as claimed in claim 1, wherein the embeddings generated by the pre-trained media transformer are multi-dimensional vector representation of each chunk from the one or more chunks, wherein the pre-trained media transformer corresponds to one of Audio Spectrogram Transformer model, Whisper model, Wav2Vec2, EnCodec, Hubert (Hidden-Unit BERT), VideoMAE, XClip, TimeSformer, ViViT, Vision Transformers (ViTs), BEiT (BERT Pre-Training of Image Transformers), CAiT (Class-Attention in Image Transformers), DeiT (Data-efficient Image Transformers) or a combination thereof.

8. The method (300) as claimed in claim 1, wherein the second classification model is configured to compare the synthetic source classification score, of each chunk, with a predefined threshold to classify the chunk belongs to the synthetic source from the one or more synthetic sources; wherein the first classification model and the second classification model comprise a combination of fully connected linear layer neural network and non-linear layer neural network, wherein the second classification model corresponds to one of a ReLU activation function, a Sigmoid activation function, logistic regression, random forest, k-nearest neighbour (k-NN), support vector machines (SVM), or a combination thereof.

9. The method (300) as claimed in claim 1, comprises training the second classification model using the one or more chunks of the input media file; wherein the method (300) comprises, during the training, utilizing one or more loss functions on the one or more chunks, to identify a wrong classification and further update the second classification model using a back propagation technique; wherein the one or more loss functions comprise a cross-entropy loss model, a triplet loss model, L2 regularizer, or a combination thereof.

10. The method (300) as claimed in claim 1, comprises receiving, a specific chunk from the one or more chunks for content analysis to determine source of the one or more chunks, wherein the specific chunk is selected by a user.

11. A system (100) for content analysis, the system (100) comprises:
a processor (201);
a memory (202) communicatively coupled to the processor (201), wherein the memory (202) is configured to store one or more executable instructions that when executed by the processor (201), cause the processor (201) to:
receive (301) an input media file;
preprocess (302) the received input media file;
split (303) the pre-processed input media file into one or more chunks;
extract (304) one or more media features corresponding to each chunk from the one or more chunks;
generate (305) embeddings of each chunk from the one or more chunks, using a pre-trained media transformer based on the extracted one or more media features;
provide (306) the generated embeddings to one or more classification models, wherein the one or more classification models comprises a first classification model and a second classification model;
calculate (307) a synthetic content classification score, using the first classification model based on the generated embeddings, wherein the synthetic content classification score is indicative of probability of the each chunk from the one or more chunks to be either real chunk or fake chunk;
calculate (308) a synthetic source classification score, using the second classification model based on the generated embeddings and the synthetic content classification score, wherein the synthetic source classification score is indicative of probability of the each chunk from the one or more chunks belongs to a synthetic source from one or more synthetic sources; and
provide (309), an information corresponding to the input media file, wherein the information comprises an indication of the input media file be either real or fake and a source of the input media file.

12. A non-transitory computer-readable storage medium having stored thereon a set
of computer-executable instructions that, when executed by a processor (201), cause the processor (201) to perform steps comprising:
receiving (301) an input media file;
preprocessing (302) the received input media file;
splitting (303) the pre-processed input media file into one or more chunks;
extracting (304) one or more media features corresponding to each chunk from the one or more chunks;
generating (305) embeddings of each chunk from the one or more chunks, using a pre-trained media transformer based on the extracted one or more media features;
providing (306) the generated embeddings to one or more classification models, wherein the one or more classification models comprises a first classification model and a second classification model;
calculating (307) a synthetic content classification score, using the first classification model based on the generated embeddings, wherein the synthetic content classification score is indicative of probability of the each chunk from the one or more chunks to be either real chunk or fake chunk;
calculating (308) a synthetic source classification score, using the second classification model based on the generated embeddings and the synthetic content classification score, wherein the synthetic source classification score is indicative of probability of the each chunk from the one or more chunks belongs to a synthetic source from one or more synthetic sources; and
providing (309), an information corresponding to the input media file, wherein the information comprises an indication of the input media file be either real or fake and a source of the input media file.
